(19) United States
(12) Patent Application Publication
(10) Pub. No.: US 2012/0136706 A1
(43) Pub. Date: May 31, 2012

(54) Digital Coupon System

(75) Inventors: Brandon R. I. Chang, Seattle, WA (US); William W. Allocca, Bellevue, WA (US); Henry R. Nickerson, Seattle, WA (US); Douglas J. Herrington, Seattle, WA (US); Dilip Kumar, Seattle, WA (US)

(73) Assignee: AMAZON TECHNOLOGIES, INC., Reno, NV (US)

(21) Appl. No.: 12/956,608

(22) Filed: Nov. 30, 2010

(51) Int. Cl. G06Q 30/00

(52) U.S. Cl. 705/14.21; 705/14.23

(57) ABSTRACT

Disclosed are various embodiments for a digital coupon system. Digital coupons can be defined by a coupon specification received from a coupon issuer. Digital coupons can be issued to users and redeemed with third party retailer sites and/or point of sale systems. A coupon clearing house application can manage distribution, redemption, reimbursement of retailers and invoicing of coupon issuers.

### BACKGROUND

Conventional coupons are often published in a newspaper or other publication and lack various features. Conventional coupons published in a publication may not be targeted at specific users a coupon issuer wishes to reach and often lack relevance to content with which they are published. Additionally, redemption may not be automated. Oftentimes, users also must physically clip and retain a physical copy of a conventional coupon in order to redeem the coupon with a retailer.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the disclosure. Moreover, in the drawings, like reference numerals designate corresponding parts throughout the several views.

FIG. 1 is a drawing of a networked environment according to various embodiments of the present disclosure.

FIG. 2 is a drawing of various components of the coupon clearinghouse application from the networked environment according to various embodiments of the present disclosure.

FIG. 3 is a drawing of an example of a user interface rendered by a client in the networked environment of FIG. 1 according to various embodiments of the present disclosure.

FIG. 4 is a drawing of an example of a user interface rendered by a client in the networked environment of FIG. 1 according to various embodiments of the present disclosure.

FIG. 5 is a drawing of an example data flow between various components from the networked environment of FIG. 1 according to various embodiments of the present disclosure.

FIG. 6 is a drawing of an example data flow between various components from the networked environment of FIG. 1 according to various embodiments of the present disclosure.

FIG. 7 is a drawing of an example data flow between various components from the networked environment of FIG. 1 according to various embodiments of the present disclosure.

FIG. 8A is a drawing of an example data flow between various components from the networked environment of FIG. 1 according to various embodiments of the present disclosure.

FIG. 8B is a drawing of an example data flow between various components from the networked environment of FIG. 1 according to various embodiments of the present disclosure.

FIG. 9 is a flowchart illustrating one example of functionality implemented as portions of the coupon clearinghouse application executed in a computing device in the networked environment of FIG. 1 according to various embodiments of the present disclosure.

FIG. 10 is a flowchart illustrating one example of functionality implemented as portions of the coupon clearinghouse application executed in a computing device in the networked environment of FIG. 1 according to various embodiments of the present disclosure.

FIG. 11 is a flowchart illustrating one example of functionality implemented as portions of the coupon clearinghouse application executed in a computing device in the networked environment of FIG. 1 according to various embodiments of the present disclosure.

FIG. 12 is a flowchart illustrating one example of functionality implemented as portions of the coupon clearinghouse application executed in a computing device in the networked environment of FIG. 1 according to various embodiments of the present disclosure.

FIG. 13 is a schematic block diagram that provides one example illustration of a computing device employed in the networked environment of FIG. 1 according to various embodiments of the present disclosure.

### DETAILED DESCRIPTION

In the following discussion, a general description of the system and its components is provided, followed by a discussion of the operation of the same. Embodiments of the present disclosure relate to systems and methods facilitating digital coupons that are issued by a coupon issuer (e.g., a manufacturer of goods), distributed to users of a digital coupon system, and redeemed with third party retailer sites or at point of sale systems. Embodiments of the disclosure also relate to a digital coupon system that facilitates redemption of digital coupons on behalf of users with a third party retailer site and/or a point of sale system. Embodiments also relate to facilitating reimbursement of third party retailer sites and/or point of sale systems honoring a digital coupon issued by a coupon issuer, and invoicing of the coupon issuer for amounts reimbursed in connection with redemption of a digital coupon issued by the coupon issuer. Embodiments also relate to publishing digital coupons in third party sites to increase distribution of digital coupons on behalf of the issuer, as well as facilitating targeting criteria so that a coupon issuer can target users meeting specific demographic or other requirements.

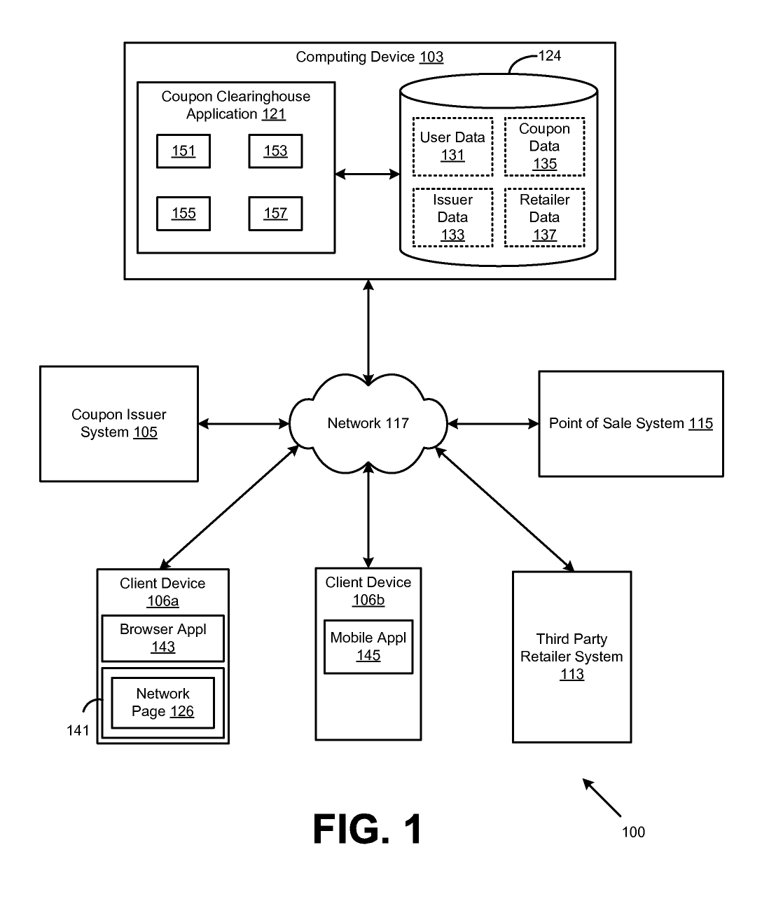

With reference to FIG. 1, shown is a networked environment 100 according to various embodiments in which a digital coupon system can be implemented. The networked environment 100 includes at least one computing device 103 that is in communication with a coupon issuer system 105, at least one client device 106, at least one third party retailer system 113 and/or at least one point of sale system 115. The various components shown in the networked environment 100 of FIG. 1 can be in communication via one or more networks 117, which can include, for example, the Internet, intranets, extranets, wide area networks (WANs), local area networks (LANs), wired networks, wireless networks, or other suitable networks, etc., or any combination of two or more such networks.

The computing device 103 may comprise, for example, a server computer or any other system providing computing capability. Alternatively, a plurality of computing devices 103 may be employed that are arranged, for example, in one or more server banks or computer banks or other arrangements. For example, a plurality of computing devices 103 together may comprise a cloud computing resource, a grid computing resource, and/or any other distributed computing arrangement. Such computing devices 103 may be located in a single installation or may be distributed among many different geographical locations. For purposes of convenience, the computing device 103 is referred to herein in the singular. Even though the computing device is referred to in the singular, it is understood that a plurality of computing devices 103 may be employed in the various arrangements as described above.

The coupon issuer system 105 can also represent one or more computing devices with which a coupon issuer can communicate with the at least one computing device 103. Likewise, the third party retailer system 113 and/or point of sale system 115 can represent one or more computing devices in communication with the at least one computing device 103 implementing the digital coupon functionality described herein. The third party retailer system 113 can implement a third party retailer site that implements an electronic commerce system where users can purchase products and/or redeem digital coupons. Similarly, the point of sale system 115 can represent one or more point of sale computing devices that are operated by a retailer, where users can purchase products and/or redeem digital coupons.

The computing device 103 is configured to execute various applications such as, for example, a coupon clearinghouse application 121 and other applications. The coupon clearinghouse application 121 is executed to facilitate distribution and redemption of digital coupons as will be described herein. The coupon clearinghouse application 121 can receive a coupon specification from a coupon issuer system 105 that defines the various properties and/or restrictions associated with a digital coupon funded by the coupon issuer. In turn, the coupon clearinghouse application 121 can make these digital coupons available to users of the coupon clearinghouse application 121. Users may “clip” these coupons or associate the digital coupons with a user account. Users can then redeem these digital coupons with a third party retailer system 113, a point of sale system 115, and/or other retailer outlets, where the coupon clearinghouse application 121 facilitates authentication of the user, validation of the digital coupon, and encumbrance of the digital coupon. In this context, encumbrance of a digital coupon can refer to expiring the digital coupon or decrementing a number of uses available for the digital coupon. The coupon clearinghouse application 121 can also receive purchase confirmations and/or settlement requests from third party retailer systems 113, point of sale systems 115, or other retail outlets in connection with purchases made by users for which a digital coupon issued by the coupon clearinghouse application 121 to the user were used.

Accordingly, the coupon clearinghouse application 121 can issue reimbursements to third party retailer systems 113, point of sale systems 115, or other retail outlets and/or their operators for discounts or other promotions designated by the digital coupon. The coupon clearinghouse application 121 can also generate reporting metrics for a coupon issuer that includes various statistics and information regarding digital coupon redemption, the users that clip digital coupons, user purchasing history, user browsing history, etc. Additionally, the coupon clearinghouse application 121 can generate an invoice for a coupon issuer in connection with reimbursements paid to third party retailer sites and/or point of sale systems. Additional details and variations of the operation of the coupon clearinghouse application 121 will be described herein.

The computing device 103 can include at least one data store 124, which may comprise data and applications operable to provide access to the data stored therein. It should be appreciated that the data store 124 may or may not reside within a computing device 103, but may be accessible via a network to the computing device 103. The data store 124 may be used to store user data 131 associated with user accounts of users of the coupon clearinghouse application 121. User data 131 can include, for example, user profile data, which can include demographic information about a user, shipping addresses, telephone numbers, payment information, e-mail addresses, purchasing history, product browsing history, a digital coupon usage history, a digital coupon clipping history, affinity groups with which the user is affiliated, and other data related to users. The user data 131 can also include data regarding digital coupons the user has clipped and are presently associated with a user account. User data 131 can also include marketing information that is imported into the data store 124 such as from a marketing database. As will be described in further detail herein, the coupon clearinghouse application 121 can also generate coupon and/or product recommendations by leveraging the data regarding users of the coupon clearinghouse application 121. The user data 131 also facilitates targeting of digital coupon campaigns created by a coupon issuer, as a campaign can be targeted at specific users based upon a purchase history, browse history, demographic information, or other information. Digital coupon campaigns can also be targeted towards members of a specific affinity group and/or membership club.

The data store 124 can also include issuer data 133, which includes data regarding coupon issuers 105. The issuer data 133 can include various data regarding a coupon issuer account accessible to the coupon clearinghouse application 121. For example, the issuer data 133 can include profile data regarding a coupon issuer, such as, but not limited to, data regarding payments for coupon campaigns, products available via an electronic commerce system that are associated with the coupon issuer, digital coupons issued by and associated with the coupon issuer, and other data as can be appreciated.

Coupon data 135 can include data regarding specific digital coupons that are specified by a coupon issuer. As noted above, a coupon issuer can, via a coupon issuer system 105, create a digital coupon campaign that is facilitated by the coupon clearinghouse application 121 by transmitting a coupon specification to the coupon clearinghouse application 121. A coupon specification can include various information regarding one or more digital coupons, such as a product identifier associated with the digital coupon as well as targeting criteria. Targeting criteria associated with a digital coupon can define requirements for users to which a digital coupon should be made available by the coupon clearinghouse application 121. A coupon specification can also specify a promotion associated with a digital coupon, which can include a discount amount the coupon issuer is willing to reimburse to a third party retailer, a complimentary or discounted product provided is association with a particular product, and other coupon promotions as can be appreciated. A discount amount can include a fixed amount and/or a percentage of a selling price. The coupon specification can also specify a digital coupon expiration date and/or campaign budget, which describes a maximum amount a coupon issuer is willing to reimburse third party retailer sites and/or point of sale system operators in connection with a digital coupon campaign.

The coupon specification can further include retailer restrictions, which can limit those third party retailers with which a digital coupon is eligible to be redeemed. In this way, in one embodiment, a coupon issuer communicating with the coupon clearinghouse application 121 via a coupon issuer system 105 can limit a digital coupon campaign to authorized dealers of a product sold by the coupon issuer. In another embodiment, the coupon issuer can limit a digital coupon campaign to retailers that served a desired demographic. Other variations should be appreciated and will be discussed in more detail herein.

The data store 124 can also include retailer data 137, which includes data regarding third party retailer systems 113, point of sale systems 115, and/or other retail outlets and their operators. Retailer data 137 can include information regarding redemptions of digital coupons issued by the coupon clearinghouse application 121 by users with various retailers. The coupon clearinghouse application 121 can facilitate redemption of digital coupons with third party retailers who may operate third party retailer systems 113, point of sale systems 115 or other systems and store data regarding the redemption in retailer data 137. Retailer data 137 can include a volume of redeemed coupons, an account balance associated with a retailer, data regarding a fraud history, data regarding products available via a particular retailer, and other data as can be appreciated. Additionally, retailer data 137 can include identifiers that specify an identity of various point of sale systems 115 that may be associated with a retailer. As can be appreciated, a retailer may operate numerous point of sale systems 115 that can interact with the coupon clearinghouse application 121. An identifier can be stored in retailer data 137 in order to identify a third party retailer associated with a point of sale system 115 and record information about coupon redemptions at the point of sale system 115 as well as enforce digital coupon restrictions.

The data store 124 can also include other data related to users, coupon issuers, retailers and digital coupons as can be appreciated, but are not necessary to discuss herein for an understanding of the various embodiments of the disclosure. Additionally, it should be appreciated that the data store 124 can be implemented in a separate computing device that may be located in a separate installation or location. The depicted table structure of the data store 124 is one example of how data can be structured therein according to embodiments of this disclosure. However, should be appreciated that data can be structured in many different ways across multiple data stores implemented in various computing devices. As one example, data related to users, coupon issuers, digital coupons, third party retailers, and other data can be extracted by the coupon clearinghouse application 121 by performing queries against data stored in the data store in wholly different table structures. Accordingly, it should be appreciated that the depicted data store 124 and the table structure shown therein is but one example given for ease of depiction and explanation of various embodiments of this disclosure.

At least one client 106 facilitates communication by a user with the coupon clearinghouse application 121 as will be described. The client 106 may comprise various types of computer systems such as, for example, a desktop, laptop, or other computer system with like capability. To this end, the client 106 may also comprise a personal digital assistant, cell phone, or other portable device with like capability as can be appreciated. The client 106 may interface with the computing device 103 using various applications such as a browser application, dedicated applications, or other applications as can be appreciated. In one embodiment, various user interfaces can be generated on a display device of the client 106 to facilitate interaction with the various systems or components implemented on the computing device 103. In this way, users may interact with the coupon clearinghouse application 121 in order to view and/or clip digital coupons available in a digital coupon system implemented by the coupon clearinghouse application 121.

As will be described in further detail herein, the coupon clearinghouse application 121 can provide one or more coupon user interfaces with which a user may interact on a client 106 in order to clip coupons rendered in the user interface. The coupon clearinghouse application 121 can display coupons according to various categories and generate coupon recommendations based on a user profile, which can also be displayed in a coupon user interface on a client.

In one embodiment, the client 106a can comprise a computing device in communication with a display device 141. The client 106a can display various user interfaces generated by the coupon clearinghouse application 121 in connection with implementing a digital coupon system. In one embodiment, the client 106a can execute a browser application 143 configured to render a network page 126 containing a coupon user interface. In another embodiment, in the case of a mobile device employed as a client 106b, a coupon user interface can be rendered in the client device 106b by a mobile application 145 that is tailored to access and communicate with the coupon clearinghouse application 121.

The coupon issuer system 105, third party retailer system 113, and/or the point of sale system 115 can also communicate with the coupon clearinghouse application 121 via user interfaces rendered in a browser executed in corresponding computing devices. Additionally, they may communicate with the coupon clearinghouse application 121 via application programming interfaces (API's) provided by the coupon clearinghouse application 121. As one example, the coupon clearinghouse application 121 can provide a web service API with which third party retailer systems 113 and/or point of sale systems 115 can communicate in order to facilitate redemption of a digital coupon by a user in association with a purchase of products in a virtual shopping cart and subsequent reimbursement of a promotion provided to the user in connection with the sale.

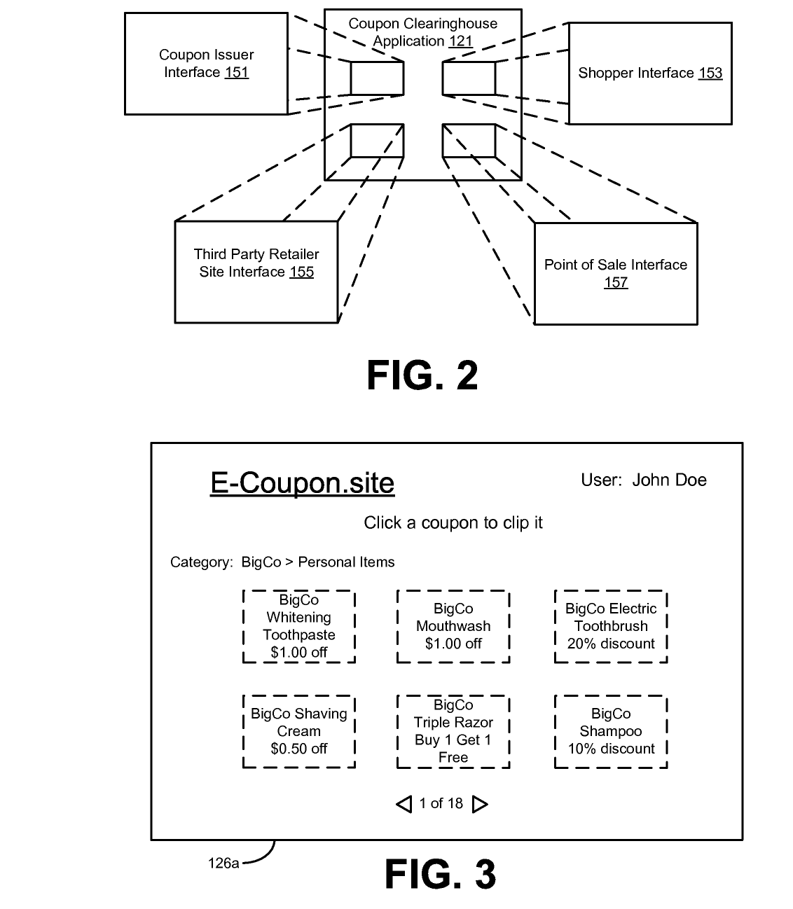

Accordingly, in order to manage the various interactions with the various entities in a digital coupon system, the coupon clearinghouse application 121 can provide various interfaces that facilitate communication with coupon issuer systems 105, users on a client 106, third party retailer system 113, and/or point of sale systems 115. To this end, the coupon clearinghouse application 121 can execute a coupon issuer interface 151, a shopper interface 153, a third party retailer site interface 155, and a point of sale interface 157. The operation of these interfaces is discussed in further detail beginning with the discussion regarding FIG. 2.

Therefore, reference is now made to FIG. 2, which depicts the coupon clearinghouse application 121 that can be executed by the computing device 103 shown in the networked environment of FIG. 1. It should be appreciated that the depicted illustration of the coupon clearinghouse application 121 and the description of various interfaces is non-limiting, and is presented for ease of describing the various interactions with various entities and/or actors in connection with a digital coupon system implemented by the coupon clearinghouse application 121. The coupon issuer interface 151 is executed by the coupon clearinghouse application 121 to interact with a coupon issuer system 105. A coupon issuer system 105 can initiate digital coupon campaigns via a digital coupon system implemented by the coupon clearinghouse application 121. The coupon issuer system 105 can transmit a coupon specification that defines at least one digital coupon via a user interface generated by the coupon issuer interface 151 and rendered on the coupon issuer system 105. Alternatively, the coupon issuer system 105 can transmit a data file to the coupon issuer interface 151 that contains a coupon specification defining at least one digital coupon. The coupon issuer interface 151 can parse the data file to determine the parameters of one or more digital coupons defined in the coupon specification received from the coupon issuer system 105. In another embodiment, the coupon issuer interface 151 can provide a network page interface and/or an application programming interface (API) accessible over a network with which a coupon issuer can interact in order to define a coupon specification.

A coupon specification received by the coupon issuer interface 151 from a coupon issuer can define various parameters and/or restrictions regarding one or more digital coupons. A coupon specification can define one or more products to which a digital coupon applies. Products can be defined by the coupon identifier by identifying one or more product identifiers. A product identifier can include a universal product code, a model number, a serial number, a stock keeping unit, or any other identifier that can uniquely identify a product or a class of products. The coupon specification can specify that a digital coupon defined by the coupon specification is applicable to a bundle of products by defining multiple products in a coupon specification and designating that multiple products identified in the specification are required to be purchased by a user in order for the digital coupon to become applicable. The coupon specification can also include a coupon issuer identifier or tracking number, which can be used by a coupon issuer to track metrics such as redemption rate, clip rate, and other metrics. To this end, the coupon issuer interface 151 can provide such an identifier or tracking number in connection with coupon metric reports and/or invoices transmitted from the coupon clearinghouse application 121 to the coupon issuer system 105.

The coupon specification received by the coupon issuer interface 151 can also define a coupon face value or a promotion applicable to one or more products or class of products identified by the coupon specification. The promotion can include an amount by which products identified by the one or more product identifiers can be discounted (e.g., a dollar amount, a percentage of a sales price, a percentage of a manufacturer's suggested retail price, etc.). Additionally, the promotion can define one or more complimentary or discounted products that can be provided to a consumer in connection with redemption of a digital coupon. In other words, the promotion can define an amount that the coupon issuer is willing to reimburse a third party retailer in connection with redemption of a digital coupon defined by the coupon specification. The coupon specification can also define an amount which the coupon issuer is willing compensate an operator of the coupon clearinghouse application 121 for each user that views and/or clips a digital coupon.

The coupon specification can additionally specify a campaign budget and/or an expiration date associated with one or more digital coupons defined by the coupon specification. A campaign budget can specify a total amount the coupon issuer is willing to reimburse retailers in connection with redemption of a digital coupon. The coupon specification can also specify one or more retailers with which the digital coupon can be used. In this way, the coupon issuer can restrict redemption of a digital coupon to a select number of third party retailer systems 113, point of sale systems 115, or other retail outlets

The coupon specification transmitted from a coupon issuer system 105 to the coupon clearinghouse 121 through the coupon issuer interface 151 can also define targeting criteria for the digital coupon. Targeting criteria can specify parameters regarding users of the coupon clearinghouse application 121 that are eligible to view and/or clip a digital coupon specified by the coupon specification. The targeting criteria, in one example, can specify that a particular digital coupon can only be viewed by a user who has purchased and/or viewed a particular product or class of products. In another example, the targeting criteria can specify that a digital coupon is only available to be clipped by users matching certain demographic information, such as, but not limited to, age, sex, income level, location, etc. In this way, a coupon issuer associated with a digital coupon can precisely target certain users, as the coupon clearinghouse application 121 maintains various information about a user in a user account that can be used to target digital coupons.

The shopper interface 153 that is executed by the coupon clearinghouse application 121 can facilitate interactions with a user associated with a user account accessible to the coupon clearinghouse application 121. The shopper interface 153 can generate a coupon user interface with which a user can view and/or clip digital coupons initiated by digital coupon campaigns from coupon issuers and that are available via the coupon clearinghouse application 121. Alternatively, the shopper interface 153 can transmit data to an application, such as the mobile application 145, that is tailored to allow a user to view and/or clip digital coupons. In some embodiments, a client device 106a/106b may execute client side code to render a user interface based at least upon data regarding digital coupons provided by the shopper interface 153.

Accordingly, shopper interface 153 can authenticate credentials of a user associated with a user account. In some embodiments, the shopper interface 153 can establish a session associated with the user account and the client device 106 on which a user is interacting with the shopper interface 153. The shopper interface 153 can transmit a session identifier, such as a browser cookie, that can be stored in a browser application 143 and/or mobile application 145 that establishes a user identifier associated with the user account. In this way, a user can browse a third party retailer site 113, which can have access to such a session identifier and/or a user identifier stored therein to establish an identity of the user within a digital coupon system implemented by the coupon clearinghouse application 121 and request information from the coupon clearinghouse application 121 regarding digital coupons associated with the user. In some embodiments, the shopper interface 153 can also obfuscate and/or encrypt identifying information within such a session identifier to protect the privacy of a user. Interactions regarding authentication of a user identity within a digital coupon system by a third party retailer system 113 will be described in further detail with reference to the discussion regarding the third party retailer site interface 155.

The shopper interface 153 can provide coupon and/or product recommendations based at least upon user profile data associated with a user account. The coupon clearinghouse application 121 can maintain user data 131 that can include coupon clipping history data, demographic information, purchase history, and other marketing data regarding a user. Accordingly, the shopper interface 153 can identify products and/or digital coupons to recommend based upon the various profile data accessible to the coupon clearinghouse application 121.

The shopper interface 153 can also transmit digital coupons associated with a user account to a mobile device associated with a user. In this way, a user can clip digital coupons available via the coupon clearinghouse application 121 and load these digital coupons on a mobile device for redemption with a third party retailer system 113, a point of sale system 115 or other retail outlets. In one embodiment, the shopper interface 153 can transmit a representation of the digital coupon to a mobile application 145 executed on a client device 106b, which can render a bar code on a display device 141 that identifies a digital coupon. A bar code scanner in communication with a point of sale system 115 can scan such a bar code for redemption of the coupon by the user in connection with a purchase of products identified by a coupon specification defining the digital coupon. The point of sale system 115 can then communicate with the coupon clearinghouse application 121 to validate and subsequently encumber the digital coupon upon redemption. Interactions between a point of sale system 115 and the coupon clearinghouse application 121 will be discussed in greater detail with reference to the discussion of the point of sale interface 157.

The third party retailer site interface 155 can be executed to facilitate interactions with a third party retailer system 113. The third party retailer site interface 155 can provide an application programming interface (API) or other appropriate interface with which a third party retailer system 113 can interact to identify users and their associated digital coupons as well as provide data regarding digital coupon redemption and reimbursement requests. In one embodiment, the third party retailer site interface 155 can provide web service API so that a third party retailer system 113 can transmit and/or receive text based data or other data regarding the various interactions between the digital coupon system and third party retailer system 113.

An account accessible to the coupon clearinghouse application 121 associated with a third party retailer system 113 can be authenticated by the third party retailer site interface 155. In some embodiments, a third party retailer system 113 can access a session identifier (e.g., a browser cookie) established by the shopper interface 153 when a user authenticates a user account via the shopper interface 153. When a user attempts to purchase one or more products via a virtual shopping cart in the third party retailer system 113, the third party retailer system 113 can transmit a user identifier associated with the session identifier to the third party retailer site interface 155, which can validate the user identity and provide one or more digital coupons associated with the user account to the third party retailer system 113. Additionally, the third party retailer system 113 can transmit one or more product identifiers associated with a virtual shopping cart of the user as well as quantities of the products in the cart. Accordingly, the third party retailer site interface 155 can transmit product identifiers and a promotion associated with the product identifiers so that the third party retailer system 113 can apply a promotion associated with one or more applicable digital coupons to eligible products associated with a virtual shopping cart of the user.

In some embodiments, the third party retailer system 113 can encrypt a user identifier and/or session identifier transmitted to the third party retailer site interface 155, which can decrypt the identifier in order to authenticate a user and provide information regarding digital coupons. In some embodiments, the third party retailer system 113 can provide additional data regarding a user in addition to the user identifier so that a user identity can be verified. As one example, the third party retailer system 113 can provide an e-mail address, name, shipping address, phone number, or other identifying data so that if, for example, a browser cookie associated with a session of the user is established on a public computer, digital coupons may not be encumbered by other users. In this scenario, the third party retailer system 113 can encrypt this additional identifying information, which can be decrypted by the third party retailer site interface 155.

In another example, the third party retailer system 113 can hash this additional identifying information and provide a hashed value and/or hash signature to the third party retailer site interface 155. The third party retailer site interface 155 can then determine whether the hashed value and/or hash signature corresponding to identifying information of the user matches a hashed value and/or hash signature corresponding to information stored about the user in the data store 124 accessible to the coupon clearinghouse application 121.

Upon receiving information regarding applicable digital coupons from the third party retailer site interface 155, the third party retailer system 113 can generate a purchase confirmation that can be received by the third party retailer site interface 155. The purchase confirmation can specify the digital coupons that were applied and/or a promotion provided to the user in connection with the purchase. Upon receiving a purchase confirmation associated with a particular user as well as one or more digital coupons applied to a purchase, the coupon clearinghouse application 121 can encumber the digital coupons associated with the account of the user. The purchase confirmation can also provide a shipment confirmation and/or shipment tracking data associated with the purchase, so that the third party retailer site interface 155 can validate shipment of the products. In one example, reimbursement of a third party retailer site can be initiated when the third party retailer site interface 155 receives a purchase confirmation from the third party retailer system 113. In other embodiments, the third party retailer system 113 can transmit a settlement request or reimbursement request in connection with a purchase confirmation to the third party retailer site interface 155, which outlines an amount by which the third party retailer 113 is to be reimbursed in connection with redemption of a digital coupon by a user. Accordingly, the third party retailer site interface 155 can initiate electronic payment to a third party retailer site operating a third party retailer system 113 and transmit a corresponding electronic confirmation. Purchase confirmations and/or reimbursement requests can be exchanged between a third party retailer system 113 and the third party retailer site interface 155 on a purchase by purchase basis or on a batch basis, whereby the third party retailer system 113 transmits a plurality of confirmations and/or an aggregate reimbursement requests associated with a plurality of purchases where digital coupons were applied.

Additionally, if a transaction that is processed by the coupon clearinghouse application 121 is cancelled after it is processed; the coupon clearinghouse application 121 can receive an order cancellation notice from a third party retailer system 113 and/or a point of sale system 115. Accordingly, the coupon clearinghouse application 121 can unencumber a digital coupon associated with a user so that it may be used again. Additionally, the coupon clearinghouse application 121 can facilitate reimbursement from a third party retailer of a coupon amount initially paid to a third party retailer in connection with the transaction.

The third party retailer site interface 155 can also enforce minimum advertised pricing rules specified by a coupon issuer in a coupon specification. Accordingly, the third party retailer site interface 155 can receive an advertised selling price associated with a product in a third party retailer system 113. If the selling price violates a minimum advertised pricing rule specified by the coupon specification associated with a digital coupon, the third party retailer site interface 155 can transmit a message to the third party retailer system 113 that denies redemption of the digital coupon.

The third party retailer site interface 155 can also receive an inventory audit report associated with products for which the third party retailer system 113 redeemed coupons on behalf of users. In this way, the third party retailer site interface 155 can perform a form of fraud detection. In some embodiments, an inventory audit report can include proof that a third party retailer site has paid for inventory covering reimbursement requests submitted by one or more third party retailer systems 113 associated with a third party retailer site to the third party retailer site interface 155 over a period of time.

In other embodiments, the third party retailer site interface 155 can transmit data regarding digital coupons associated with a user account that are in turn associated with products that may not be in a virtual shopping cart on the third party retailer system 113. In this way, the third party retailer system 113 can provide additional product recommendations for products available via the third party retailer system 113 that are relevant to digital coupons associated with a user account, even though these products may not be in a virtual shopping cart of the user. Additionally, the third party retailer site interface 155 can transmit information regarding digital coupons available via a digital coupon system implemented by the coupon clearinghouse application 121 that are not presently associated with a user account, and that correspond to products available via the third party retailer system 113 so that the third party retailer system 113 can recommend these products and/or digital coupons.

The point of sale system interface 157 can be executed by the coupon clearinghouse application 121 to facilitate redemption of digital coupons in a point of sale system 115 in communication with a digital coupon system implemented by the coupon clearinghouse application 121. As noted above, in one embodiment, digital coupons associated with a user account can be transmitted to a mobile application 145, which can display a bar code or provide another identifier associated with the digital coupon. In some embodiments, a mobile device can wirelessly communicate with the point of sale system 115 via a wireless networking protocol and perform a handshake with the point of sale system to exchange data. In other embodiments, the point of sale system 115 and a mobile device can communicate with a network such as the Internet. A representation of the digital coupon can be generated by the shopper interface 153 such that it uniquely identifies the digital coupon and/or the user account with which the digital coupon is associated. A point of sale system 115 can receive a bar code or other identifier associated with the digital coupon and transmit the identifier to the point of sale system interface 157 to validate whether the digital coupon should be redeemed or honored by the point of sale system.

The point of sale interface 157 can validate the digital coupon presented by a user via a mobile device by receiving an identifier that identifies the digital coupon as well as products associated with a purchase in the point of sale system 115. The point of sale interface 157 can then determine whether a promotion associated with the digital coupon should be provided to the user in connection with the purchase by determining whether the products associated with the purchase qualify for the promotion, whether the digital coupon remains valid due to a campaign budget and/or an expiration date specified by a coupon specification, and/or whether the digital coupon remains valid due to its being used in excess of a number of uses specified by the coupon specification. Upon validating a digital coupon received from the point of sale system 115 in this way, the point of sale interface 157 can encumber the digital coupon associated with the user account as described above.

In other embodiments, the point of sale system 115 can receive a user identifier associated with a user and transmit the user identifier to the point of sale interface 157, which can transmit one or more digital coupons associated with the user account and/or digital coupons that are applicable to one or more products in connection with a purchase by the user at the point of sale system 115. Accordingly, in such a scenario a mobile device or other client 106 associated with a user can perform a handshake to provide a user identifier to the point of sale system 115.

The point of sale interface 157, in some embodiments, can also provide a plurality of digital coupons that can be cached in a point of sale system 115 and/or on a data store in communication with the point of sale system 115 so interactions between the point of sale system 115 and/or need not take place in connection with each purchase made at a point of sale system 115.

In addition to the above-described interactions between the various interfaces and a coupon clearinghouse application 121, the coupon clearinghouse application 121 can also syndicate digital coupons from the coupon data 135 so that digital coupons can be published on associate sites. Such syndication can increase distribution of digital coupons and encourage clipping and/or redemption of coupons. Accordingly, the coupon clearinghouse application 121 can generate a publishing feed associated with digital coupons that an associate site can receive and publish. In some embodiments, the publishing feed can take into account relevance to content on an associate site as well as relevance to location based data that can be detected in a client on which a user is viewing an associate site. In this way, by increasing relevance of the digital coupons syndicated by the coupon clearinghouse application 121, the coupon clearinghouse application 121 can further encourage clipping and/or redemption of the syndicated coupons.

Referring next to FIG. 3, shown is a network page 126a that can be generated by the shopper interface 153. The depicted network page 126a includes a coupon user interface that is generated by the shopper interface 153 and rendered in a browser application 143 on a client device 106a. It should be appreciated that a coupon user interface can also be rendered in a mobile application 145 or any application tailored to access the coupon clearinghouse application 121 according to various embodiments of the disclosure.

The depicted coupon user interface illustrates one example of digital coupons that can be displayed to a user for clipping and/or associating with a user account. Additionally, the shopper interface 153 can generate a coupon user interface that allows a user to browse and/or clip coupons according to a product category. In some embodiments, as in the depicted network page 126a, the shopper interface 153 can display digital coupons associated with a particular coupon issuer.

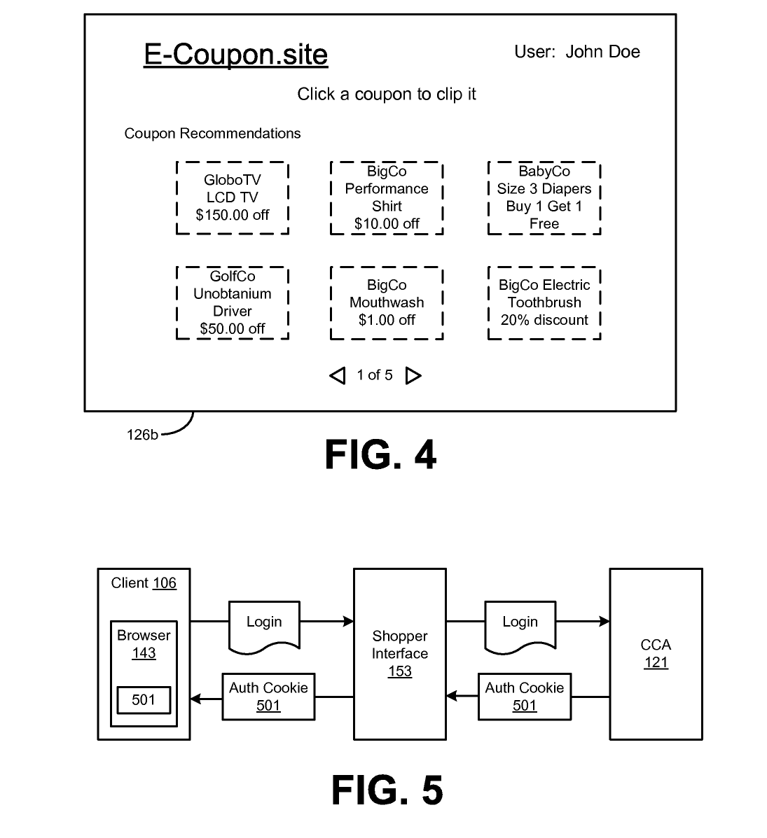

Reference is now made to FIG. 4, which depicts an alternative coupon user interface. The depicted network page 126b illustrates a coupon user interface in which coupon recommendations generated by the shopper interface 153 can be displayed. As noted above, the coupon recommendations can be based upon a purchase history, coupon clipping history, and other data that can be associated with a user account.

Reference is now made to FIG. 5, which depicts the flow of data between a client device 106a/106b and the shopper interface 153. FIG. 5 depicts one way in which a user can be authenticated, and a session identifier stored in the client device 106a/106b so that third party retailer sites 113 can access the identifier to retrieve digital coupons associated with a user account. In the depicted figure, a client 106 can submit login credentials to the shopper interface 153, which can verify the login credentials in user data 131 accessible to the coupon clearinghouse application 121. Accordingly, a session identifier (e.g., an authorization cookie 501) can be generated that can be stored accessible to a browser application 143 or other application executing on a client.

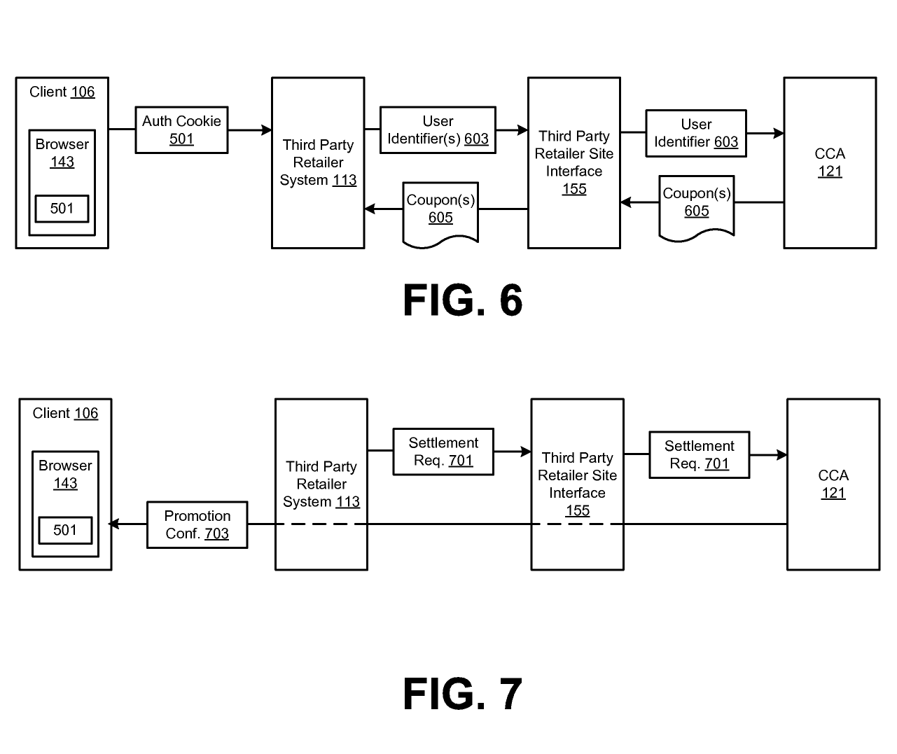

Reference is now made to FIG. 6, which continues the example of FIG. 5 and illustrates a user accessing a third party retailer system 113 on a client in which an authorization cookie 501 generated by the shopper interface 153 is stored. The browser application 143 executed on a client device 106 can provide the authorization cookie 501 to the third party retailer site, which can generate a user identifier 603 that can be provided to the third party retailer site interface 155 for identification of the user. As noted above, the user identifier 603 generated by the third party retailer system 113 can include data from the authorization cookie 501 and be supplemented with other identifying information associated with a user account and/or a virtual shopping cart in the third party retailer system 113. The user identifier 603 can also be encrypted or hashed to protect user privacy. The user identifier 603 can also include or be transmitted with product identifiers associated with a virtual shopping cart in the third party retailer system 113 so that the coupon clearinghouse application 121 can identify applicable digital coupons.

Accordingly, the user identifier 603 can be received by the third party retailer site interface 155, and a user account associated with the identifier identified in the coupon clearinghouse application 121. The coupon clearinghouse application 121 can, via the third party retailer site interface 155, transmit at least one digital coupon associated with the user account and/or products in a virtual shopping cart for redemption via the third party retailer system 113.

Reference is now made to FIG. 7, which continues the example of FIG. 6. Upon completion of a purchase in the third party retailer system 113, the third party retailer system 113 can transmit to the third party retailer site interface 155 a settlement request 701 and/or purchase confirmation as described above. Additionally, in some embodiments, the coupon clearinghouse application 121 and/or shopper interface 153 can transmit a promotion confirmation to a user and/or a client 106 associated with the user as a fraud prevention measure as well as a validation measure to ensure the user has received a particular promotion associated with a digital coupon. In this way, a user can verify whether a promotion specified by a digital coupon redeemed by the third party retailer system 113 is applied to the purchase.

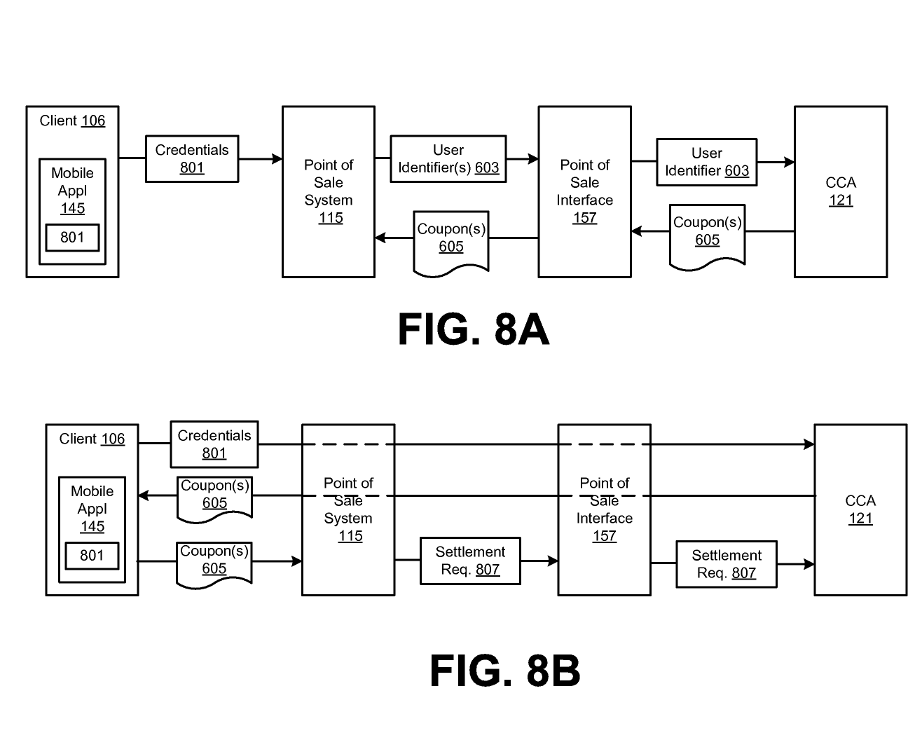

Referring next to FIG. 8A, shown is an alternative example that illustrates the flow of data, in one embodiment between a point of sale system 115 and the coupon clearinghouse application 121. In the depicted example, a user on a client 106 can use a mobile application 145 to interact with a point of sale system. As described above, a mobile application 115 can perform a handshake with a point of sale system 115 and provide credentials 801 for authentication with the coupon clearinghouse application 121. The point of sale system 115 can generate a user identifier 603, which can include the credentials 801 as well as potentially other information that can be used to authenticate the user to the coupon clearinghouse application 121, which identify a user account and retrieve digital coupons 605 associated with a user account of the user. The digital coupons 605 associated with the user account and/or the products associated with a purchase in the point of sale system 115 can be transmitted to the point of sale system 115, which can apply a promotion defined by the digital coupon.

FIG. 8B illustrates an alternative example of interactions with a point of sale system 115. In the depicted example, the mobile application 145 can provide credentials 801 directly to the coupon clearinghouse application 121 and/or a shopper interface 153. Accordingly, the coupon clearinghouse application 121 can transmit digital coupons directly to the mobile application 145. In one embodiment, the mobile application 145 can be configured to capture a UPC, product imagery, or other information about a product and the coupon clearinghouse application 121 can identify a product associated therewith, assign the digital coupons to the user account, and transmit any applicable digital coupons 605 to the mobile application 145.

The mobile application 145 can then provide the digital coupons to the point of sale system 115, which can apply a promotion specified by the coupons and generate a settlement request 807 that can be transmitted to the point of sale interface 157. In some embodiments, the point of sale system 115 can transmit a validation request to the point of sale interface 157, which can validate any digital coupons 605 provided by a mobile application 145 to the point of sale system 115. Accordingly, the point of sale interface 157 can determine whether digital coupons are valid and issue a validation response to the point of sale system 115. If the digital coupons 605 are determined to be valid, then the point of sale system 115 can apply a promotion specified by the digital coupons 605 to a purchase at the point of sale system 115.

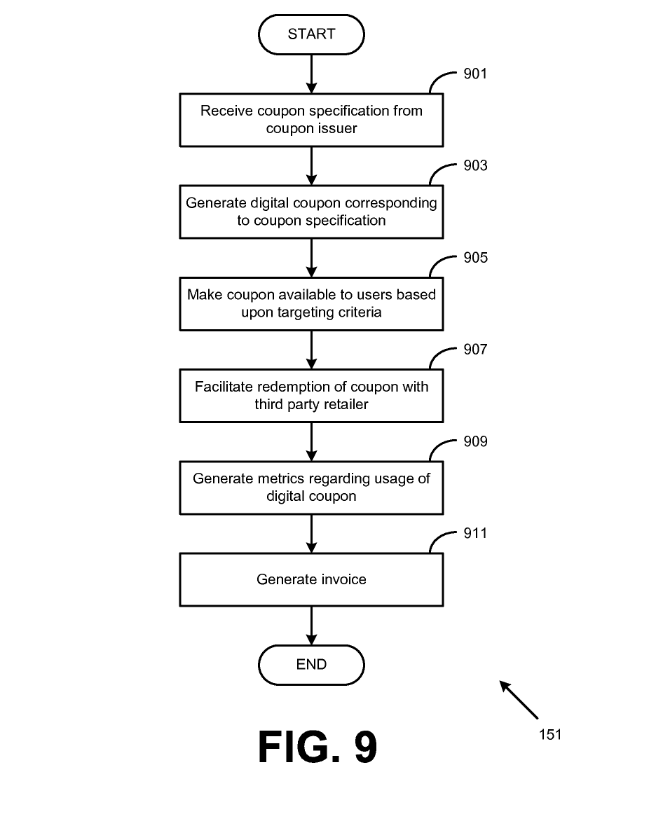

Referring next to FIGS. 9-12, shown are various flowcharts that provide examples of the operation of the coupon issuer interface 151, the shopper interface 153, and the third party retailer site interface 155 according to various embodiments. It is understood that the flowcharts of FIGS. 9-12 provide merely examples of the many different types of functional arrangements that may be employed to implement the operation of the portion of the coupon clearinghouse application 121 as described herein. As an alternative, the flowcharts of FIGS. 9-12 may be viewed as depicting an example of steps of a method implemented in the computing device 103 (FIG. 1) according to one or more embodiments.

With reference to FIG. 9, which illustrates one example of operation of the coupon issuer interface 151, beginning with box 901, a coupon specification is received from a coupon issuer, the coupon specification defining at least one digital coupon. In box 903, a digital coupon is generated by the coupon clearinghouse application 121. In box 905, the digital coupon is made available to users of a digital coupon system implemented by the coupon clearinghouse application 121 based upon targeting criteria specified in the coupon specification.

In box 907, the coupon clearinghouse application 121 can facilitate redemption of the digital coupon with third party retailer sites, and in boxes 909 and 911, the coupon issuer interface 151 can generate metrics regarding distribution, clipping and usage of the coupon as well as invoice the coupon issuer for reimbursements paid by the digital coupon system implemented by the coupon clearinghouse application 121 to third party retailer sites 113 in connection with digital coupon redemptions.

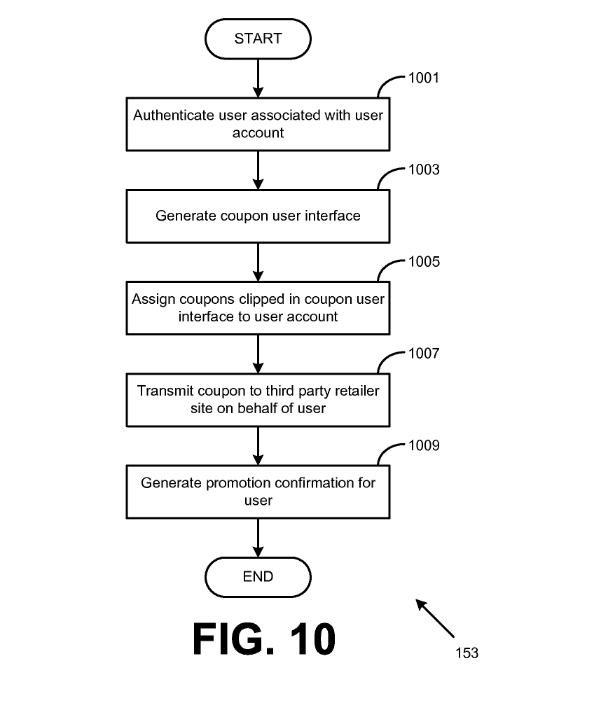

Reference is now made to FIG. 10, which illustrates one example of operation of the shopper interface 153 executed by the coupon clearinghouse application 121. Beginning with box 1001, the shopper interface 153 authenticates a user associated with a user account accessible to the shopper interface 153. In box 1003, the shopper interface 153 generates a coupon user interface with which a user can view and/or clip digital coupons available via the coupon clearinghouse application 121. In box 1005, the shopper interface assigns digital coupons clipped by the user to a user account associated with the user. In box 1007, the shopper interface transmits one or more digital coupons associated with a purchase to a third party retailer system 113, a point of sale system 115, and/or another retail outlet. In box 1009, the shopper interface can generate a promotion confirmation associated with a purchase for a user.

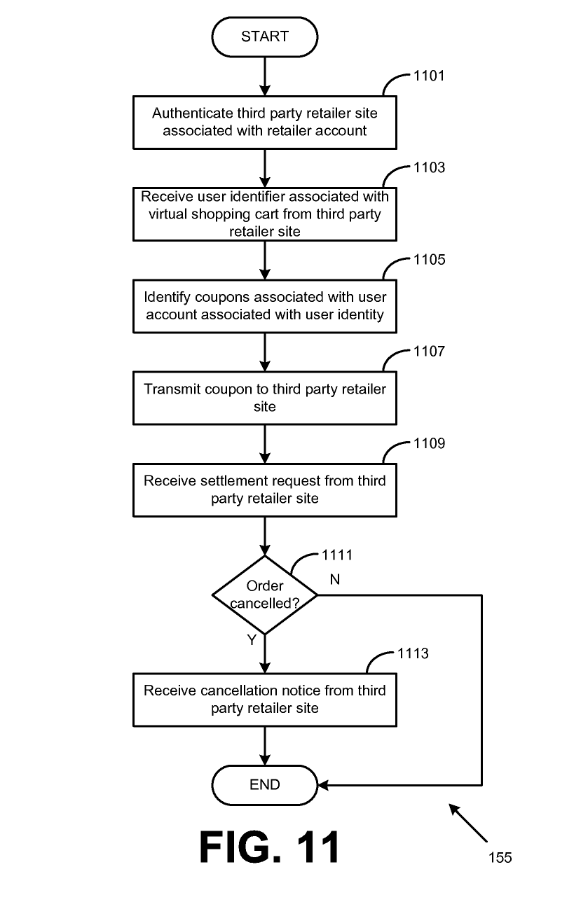

Reference is now made to FIG. 11, which illustrates one example of operation of a third party retailer site interface 155 executed by the coupon clearinghouse application 121. Beginning with box 1101, the third party retailer site interface 155 authenticates a third party retailer system 113 associated with a third party retailer site account in a digital coupon system implemented by the coupon clearinghouse application 121. In box 1103, the third party retailer site interface 155 receives a user identifier from the third party retailer system 113 that is associated with a virtual shopping cart of a user in the third party retailer system 113.

In box 1105, the third party retailer site interface 155 identifies one or more digital coupons associated with the user identity associated with the user identifier and transmits data regarding the digital coupons to the third party retailer system 113 in box 1107. In box 1109, the third party retailer site interface 155 can receive a settlement request from the third party retailer system 113 in connection with a purchase in which digital coupons were redeemed. The settlement request can include information about the amount and quantity of digital coupons redeemed by the user in connection with the purchase. The settlement request can also include a shipment confirmation generated by the third party retailer site. Accordingly, when the settlement request is received by the third party retailer site interface 155, the coupon clearinghouse application 121 can encumber the digital coupons redeemed in connection with the purchase so that a user may not use the digital coupons more than as specified by a corresponding coupon specification. Additionally, if an order placed and/or settled in connection with a digital coupon is cancelled in box 1111, the third party retailer site interface 155 can receive an order cancellation notice from the third party retailer site in box 1113. Accordingly, in such a scenario, the third party retailer site interface 155 can facilitate unencumbering of the digital coupon encumbered in connection with the transaction.

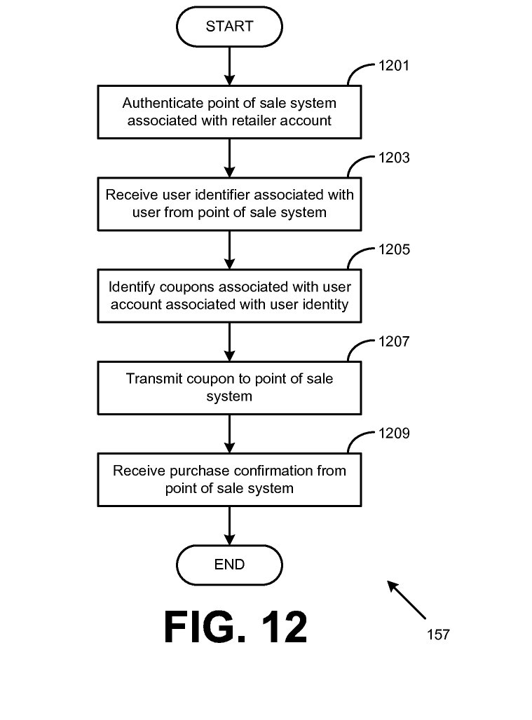

Reference is now made to FIG. 12, which illustrates one example of operation of a point of sale interface 157 executed by the coupon clearinghouse application 121. In box 1201, the point of sale interface 157 authenticates a point of sale system 115 associated with a retailer account. In box 1203, the point of sale interface 157 receives a user identifier received from the point of sale system 115 that corresponds to a user in connection with a purchase via the point of sale system 115. The point of sale system 115 can also transmit one or more product identifiers associated with products in connection with the purchase. In box 1205, the point of sale interface 157 executed by the coupon clearinghouse application 121 can identify digital coupons associated with a user account, and in box 1207, the point of sale interface 157 can transmit identified digital coupons to the point of sale system 115. Finally, in box 1209, the point of sale system can receive a purchase confirmation from the point of sale system in connection with the purchase.

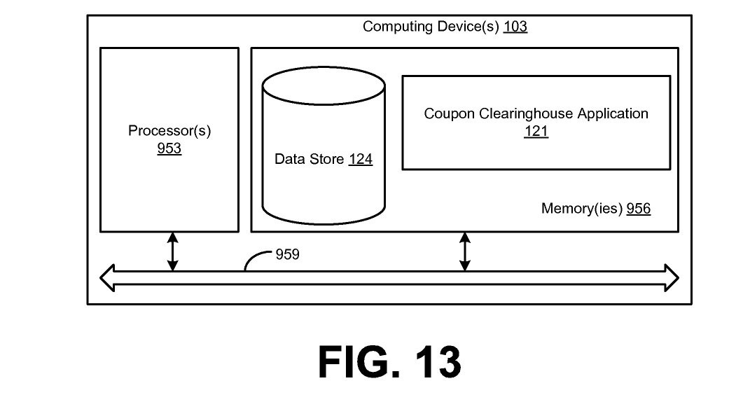

With reference to FIG. 13, shown is a schematic block diagram of the computing device 103 according to an embodiment of the present disclosure. The computing device 103 includes at least one processor circuit, for example, having a processor 953 and a memory 956, both of which are coupled to a local interface 959. To this end, the computing device 103 may comprise, for example, at least one server computer or like device. The local interface 959 may comprise, for example, a data bus with an accompanying address/control bus or other bus structure as can be appreciated.

Stored in the memory 956 are both data and several components that are executable by the processor 953. In particular, stored in the memory 956 and executable by the processor 953 are the coupon clearinghouse application 121 and potentially other applications. Also stored in the memory 956 may be a data store 124 and other data. In addition, an operating system may be stored in the memory 956 and executable by the processor 953.

It is understood that there may be other applications that are stored in the memory 956 and are executable by the processors 953 as can be appreciated. Where any component discussed herein is implemented in the form of software, any one of a number of programming languages may be employed such as, for example, C, C++, C#, Objective C, Java, Javascript, Perl, PHP, Visual Basic, Python, Ruby, Delphi, Flash, or other programming languages.

A number of software components are stored in the memory 956 and are executable by the processor 953. In this respect, the term “executable” means a program file that is in a form that can ultimately be run by the processor 953. Examples of executable programs may be, for example, a compiled program that can be translated into machine code in a format that can be loaded into a random access portion of the memory 956 and run by the processor 953, source code that may be expressed in proper format such as object code that is capable of being loaded into a random access portion of the memory 956 and executed by the processor 953, or source code that may be interpreted by another executable program to generate instructions in a random access portion of the memory 956 to be executed by the processor 953, etc. An executable program may be stored in any portion or component of the memory 956 including, for example, random access memory (RAM), read-only memory (ROM), hard drive, solid-state drive, USB flash drive, memory card, optical disc such as compact disc (CD) or digital versatile disc (DVD), floppy disk, magnetic tape, or other memory components.

The memory 956 is defined herein as including both volatile and nonvolatile memory and data storage components. Volatile components are those that do not retain data values upon loss of power. Nonvolatile components are those that retain data upon a loss of power. Thus, the memory 956 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 953 may represent multiple processors 953 and the memory 956 may represent multiple memories 956 that operate in parallel processing circuits, respectively. In such a case, the local interface 959 may be an appropriate network that facilitates communication between any two of the multiple processors 953, between any processor 953 and any of the memories 956, or between any two of the memories 956, etc. The local interface 959 may comprise additional systems designed to coordinate this communication, including, for example, performing load balancing. The processor 953 may be of electrical or of some other available construction.

Although the coupon clearinghouse application 121 and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, or other components, etc. Such technologies are generally well known by those skilled in the art and, consequently, are not described in detail herein.

The flowcharts of FIGS. 9-12 show the functionality and operation of an implementation of portions of the coupon clearinghouse application 121. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 953 in a computer system or other system. The machine code may be converted from the source code, etc. If embodied in hardware, each block may represent a circuit or a number of interconnected circuits to implement the specified logical function(s).

Although the flowcharts of FIGS. 9-12 show a specific order of execution, it is understood that the order of execution may differ from that which is depicted. For example, the order of execution of two or more blocks may be scrambled relative to the order shown. Also, two or more blocks shown in succession in FIGS. 9-12 may be executed concurrently or with partial concurrence. Further, in some embodiments, one or more of the blocks shown in FIGS. 9-12 may be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including coupon clearinghouse application 121, that comprises software or code can be embodied in any non-transitory computer-readable medium for use by or in connection with an instruction execution system such as, for example, a processor 953 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. The computer-readable medium can comprise any one of many physical media such as, for example, magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

It should be emphasized that the above-described embodiments of the present disclosure are merely possible examples of implementations set forth for a clear understanding of the principles of the disclosure. Many variations and modifications may be made to the above-described embodiment(s) without departing substantially from the spirit and principles of the disclosure. All such modifications and variations are intended to be included herein within the scope of this disclosure and protected by the following claims.

Therefore, the following is claimed:

1. A non-transitory computer-readable medium embodying a program executable in a computing device, the program comprising:
code that receives at least one coupon specification from a coupon issuer, the coupon specification specifying at least one product identifier;
code that generates at least one digital coupon based at least upon the at least one coupon specification;
code that assigns the at least one digital coupon to at least one user associated with a user account;
code that verifies an identity of a user associated with a session in the third party retailer site;
code that identifies at least one product associated with a virtual shopping cart of the user in the third party retailer site;
code that determines whether the at least one coupon applies to the at least one product;
code that transmits the promotion to the third party retailer site; and
code that facilitates reimbursement of a third party retailer, the reimbursement being equivalent to the promotion.

2. A system, comprising:
at least one computing device; and
a coupon clearinghouse application executable in the at least one computing device, the coupon clearinghouse application comprising:
logic that receives at least one coupon specification from a coupon issuer, the coupon specification specifying at least one product identifier;
logic that generates at least one digital coupon based at least upon the at least one coupon specification;
logic that assigns the at least one digital coupon to at least one user associated with a user account;
logic that facilitates redemption of the at least one digital coupon with a third party retailer site; and
logic that generates a report detailing a number of redemptions of the at least one coupon.

3. The system of claim 2, wherein the coupon clearinghouse application further comprises logic that generates a publishing feed for the at least one coupon, the publishing feed facilitating publication of the at least one coupon on an associate site.

4. The system of claim 3, wherein the logic that generates a publishing feed further comprises:
logic that analyzes content on a page of the third party site;
logic that selects a subset of the at least one coupon having relevance to the content on the page of the third party site; and
logic that provides the subset of the at least one coupon in the publishing feed.

5. The system of claim 2, wherein the at least one coupon specification further comprises:
at least one promotion, the at least one promotion specifying at least one of a discount and a complimentary item associated with the at least one coupon; and
at least one internal identifier, the at least one internal identifier comprising an identifier with which the coupon issuer can track the at least one coupon specification.

6. The system of claim 5, wherein the at least one coupon specification further comprises:
a campaign budget specifying a total budget associated with a coupon specified by the coupon issuer; and
at least one set of targeting criteria associated with the at least one coupon, the at least one set of targeting criteria specifying user profile data to which the at least one coupon is targeted.

7. The system of claim 2, further comprising a user data store, the user data store configured to store profile data regarding users, the profile data further comprising data regarding coupons assigned to each of the users.

8. The system of claim 7, wherein the coupon clearinghouse application further comprises logic that generates marketing data associated with each of the users from the user profile data in the user data store, the marketing data further comprising:
at least one third party site a user frequents;
at least one digital coupon issued to the user that the user has redeemed; and
a purchase history associated with the user.

9. The system of claim 7, wherein the coupon clearinghouse application further comprises logic that generates at least one coupon recommendation for a user, the at least one coupon recommendation generated from at least one of: a purchase history associated with the user, a browsing history associated with the user, and marketing data imported into a user profile associated with the user.

10. The system of claim 2, further comprising logic that encodes for display a coupon user interface, the coupon user interface facilitating adding of digital coupons to a user profile.

11. The system of claim 2, wherein the coupon clearinghouse application further comprises:
logic that generates a clip report detailing a total number of users clipping the at least one coupon;
logic that generates a metrics report detailing profile characteristics of the users clipping the at least one coupon; and
logic that generates a retailer report detailing retailer characteristics of third party retailer sites at which the at least one coupon is redeemed.

12. The system of claim 5, wherein the logic that facilitates redemption of the at least one coupon at a third party retailer site further comprises:
logic that verifies an identity of a user associated with a session in the third party retailer site;
logic that identifies at least one product associated with a virtual shopping cart of the user in the third party retailer site;
logic that determines whether the at least one coupon applies to the at least one product;
logic that transmits the promotion to the third party retailer site; and
logic that facilitates reimbursement of a third party retailer.

13. A method, comprising the steps of:
receiving, in at least one computing device, at least one coupon specification from a coupon issuer, the coupon specification specifying at least one product identifier;
generating, in the at least one computing device, at least one digital coupon based at least upon the at least one coupon specification;
assigning, in the at least one computing device, the at least one digital coupon to at least one user associated with a user account;
tracking, in the at least one computing device, redemption of the at least one digital coupon with at least one of a third party retailer site and a point of sale system; and
generating, in the at least one computing device, metrics detailing at least one statistic about redemption of the at least one digital coupon.

14. The method of claim 13, further comprising the step of generating a publishing feed for the at least one coupon, the publishing feed facilitating publication of the at least one coupon on an associate site.

15. The method of claim 14, wherein the metrics further comprise at least one statistic about a number of views of the at least one digital coupon and a number of users clipping the at least one digital coupon.

16. The method of claim 3, wherein the step of generating a publishing feed further comprises:
analyzing, in the at least one computing device, content on a page of the associate site;
selecting, in the at least one computing device, a subset of the at least one coupon having relevance to the content on the page of the associate site; and
providing, in the at least one computing device, the subset of the at least one coupon in the publishing feed.

17. The method of claim 13, wherein the at least one coupon specification further comprises:
at least one discount associated with the at least one product identifier, the at least one discount specifying at least one of: a percentage of a selling price and a fixed amount discounted from the selling price; and
at least one internal identifier, the at least one internal identifier comprising an identifier with which the coupon issuer can track the at least one coupon specification.

18. The method of claim 17, wherein the at least one coupon specification further comprises a campaign budget specifying a total budget associated with a coupon specified by the coupon issuer, the total budget; and
the step of tracking redemption of the at least one digital coupon further comprises deducting a discount specified by the coupon specification and a redemption fee from the campaign budget when the at least one digital coupon is redeemed.

19. The method of claim 13, wherein the at least one coupon specification further comprises at least one set of targeting criteria associated with the at least one coupon, the at least one set of targeting criteria specifying user profile data to which the at least one coupon is targeted.

20. The method of claim 13, further comprising the step of storing the at least one digital coupon assigned to the at least one user in a user data store accessible to the at least one computing device, the user data store further comprising user profile data associated with each of the user accounts.

21. The method of claim 20, further comprising the step of generating marketing data from the user profile data associated with each of the users in the user data store, the marketing data further comprising:
at least one third party site a user has visited;
at least one digital coupon issued to the user that the user has redeemed; and
a purchase history associated with the user.

22. The method of claim 20, further comprising the steps of:
generating at least one coupon recommendation for a user, the at least one coupon recommendation generated from at least one of: a purchase history associated with the user, a browsing history associated with the user, and marketing data imported into a user profile associated with the user.

23. The method of claim 13, further comprising the step of encoding for display a coupon user interface, the coupon user interface facilitating assigning of digital coupons to a user profile by a user on a client.

24. The method of claim 13, wherein the step of generating metrics about the at least one digital coupon further comprising the steps of:
generating at least one statistic detailing user profile characteristics of the users clipping the at least one coupon; and
generating at least one statistic detailing retailer characteristics of third party retailer sites with which the at least one coupon is redeemed.

25. The method of claim 17, further comprising the steps of:
verifying an identity of a user associated with a session in the at least one of the third party retailer site and the point of sale system;
identifying at least one product associated with a virtual shopping cart of the user;
determining whether the at least one coupon applies to the at least one product;
transmitting the at least one discount associated with the at least one product to the third party retailer site; and
encumbering the at least one digital coupon associated with the user account.
